(19) United States
(12) Patent Application Publication
(10) Pub. No.: US 2014/0168098 A1
(43) Pub. Date: Jun. 19, 2014

(54) APPARATUS AND ASSOCIATED METHODS

(71) Applicant: NOKIA CORPORATION, Espoo (FI)

(72) Inventors: Andres Lucero, Tampere (FI); Petri Piippo, Lempaala (FI); Juha Arrasvuori, Tampere (FI); Marion Boberg, Suinula (FI)

(73) Assignee: NOKIA CORPORATION, Espoo (FI)

(21) Appl. No.: 13/717,284

(22) Filed: Dec. 17, 2012

(51) Int. Cl. G06F 3/041

(52) U.S. Cl. CPC G06F 3/041
USPC 345/173; 345/156

(57) ABSTRACT

An apparatus, the apparatus comprising at least one processor, and at least one memory including computer program code, the at least one memory and the computer program code configured, with the at least one processor, to cause the apparatus to perform at least the following: when the determined relative position of a first portable electronic device with respect to a second electronic device is within a predetermined overlying proximity position in which at least a portion of the first portable electronic device overlies the second electronic device, consider at least one of input from or for the first portable electronic device as input for the second electronic device, and output from or for the second electronic device as output from the first portable electronic device.

### TECHNICAL FIELD

The present disclosure relates to user interfaces, associated methods, computer programs and apparatus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs), mobile telephones, smartphones and other smart devices, and tablet PCs.

The portable electronic devices/apparatus according to one or more disclosed aspects/embodiments may provide one or more audio/text/video communication functions (e.g. tele-communication, video-communication, and/or text transmission (Short Message Service (SMS)/Multimedia Message Service (MMS)/emailing) functions), interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Different electronic devices provide different ways by which an input may be made, and by which output is provided. Certain electronic devices allow input to be made, for example, by clicking a pointer or touching a touch-sensitive screen. Output may be provided from an electronic device, for example, via a high resolution display screen.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

In a first aspect there is provided an apparatus, the apparatus comprising at least one processor and at least one memory including computer program code, the at least one memory and the computer program code configured, with the at least one processor, to cause the apparatus to perform at least the following: when the determined relative position of a first portable electronic device with respect to a second electronic device is within a predetermined overlying proximity position in which at least a portion of the first portable electronic device overlies the second electronic device, consider at least one of input from or for the first portable electronic device as input for the second electronic device and output from or for the second electronic device as output from the first portable electronic device.

For example, a smartphone may be placed on a tablet computer screen. At least parts of images (output) displayed on the tablet computer screen may be displayed (output) on the smartphone screen. Inputs made using a touch and hover sensitive screen of the smartphone may be accepted as inputs for the tablet computer. Such treatment of the input and/or output made to one device being recognised by the other device may provide advantages to a user. For example, if a user wishes to use a hover gesture to make an input to the tablet computer, but the tablet computer does not recognise hover gestures, the user is able to make the hover gesture via the touch and hover sensitive screen of the smartphone and this input would be recognised as input by the tablet computer. If the user wishes to make the hover gesture input in relation to a particular element displayed on the tablet computer, then the smartphone may display the particular element as output on its own display so that the user can see where he/she wishes to make the hover gesture input using the smartphone so that the input is recognised as associated with the particular displayed element.

The apparatus is configured to consider input and/or output as disclosed herein when the determined relative position of a first portable electronic device with respect to a second electronic device is within a predetermined overlying proximity position in which at least a portion of the first portable electronic device overlies the second electronic device. The determined relative position may change in time (for example, if a user moves the first portable electronic device from the left side to the right side of a second electronic device). However, at any one point in time, the first portable electronic device and the second electronic device have a particular relative position which is determined (the determined relative position).

The predetermined overlying proximity position may be at least one of a position in which at least a portion of a display of the first portable device overlies a display of the second electronic device, and a position in which an entire display of the first portable device overlies a larger display of the second electronic device. Thus in the example of a smartphone and a tablet computer, the smartphone may be placed on the tablet computer screen, so that either a part of the smartphone is over the tablet computer, or so that all of the smartphone is over the tablet computer.

The apparatus may be configured to consider the input from or for the first portable electronic device as input for the second electronic device by taking input signalling from or for the first portable electronic device and providing it as input signalling for the second electronic device. In this way an input may be made to the first device, and input signalling may be transmitted from the first to the second device so that the second device receives the input.

The apparatus may be configured to consider the output from or for the second electronic device as output from the first portable electronic device by taking output signalling from or for the second electronic device and providing it as input for the first portable electronic device to allow for output by the first portable electronic device. In this way, for example, an image displayed as output from the second device may be displayed as output from the first device due to the (direct/indirect) transmission of display signalling from the second to the first device instructing the first device to display the image from the second device.

The apparatus may be configured to consider the output from or for the second electronic device as output from the first portable electronic device by providing output display signalling to one or more of the devices such that displays of the respective devices work together in concert. The displays of the respective devices may work together in concert such that, for example, the display of the first portable electronic device provides a magnification of a (underlying or non-underlying) portion of an image represented on the display of the second electronic device. As another example, the display of the first portable electronic device may provide a portion of an image represented on the display of the second electronic device which is at least partially obscured by the overlying first portable electronic device. Thus for example an image or part of an image displayed on the second device may be displayed as a magnified or non-magnified image using the first device.

As another example the display of the first portable electronic device may provide a portion of an image represented on the display of the second electronic device. The portion of the image may be an image which can still be seen on a display of the second device even when the first device is positioned proximally to the second device, or may be a portion of an image which can no longer be seen on a display of the second device due to the proximal positioning of the first device with respect to the second device. The image shown using the first device may be a copy of the entire image shown on a display of the second device, or part of which is no longer visible due to being obscured by the proximal position of the first device to the display of the second device (i.e., over the display of the second device).

As another example the display of the first portable electronic device may provide a menu associated with content provided on the display of the second electronic device. As a further example the display of the first portable electronic device may provide a portion of an image which was, immediately prior to the first and second devices being in the predetermined overlying proximity, represented on the display of the second electronic device. For example, the second device may determine that the first device is located over part of the display screen of the first device, and upon this determination of the device positioning, display an image using the second device, such as an image that is obscured by the position of the second device.

The apparatus may be configured to determine whether the relative position of the first portable device with respect to the second portable device is within the predetermined overlying proximity position. This determination may of course be performed by other apparatus.

The predetermined overlying proximity position may comprise the first portable electronic device proximally located over the second electronic device such that both a display of the first portable electronic device and a display of the second electronic device are facing substantially the same direction. For example, a tabletop display may be considered as a second device, and a tablet computer as a first portable device may be laid over the tabletop display such that a user looking at the tabletop display can also see the display of the tablet computer. The tablet computer may be considered as a type of sub-display of the tabletop display.

The input from or for the first portable electronic device may be a user input made using a user interface of the first portable electronic device. Examples include touch user inputs via touch sensitive displays and hover inputs via a hover sensitive screen/sensor.

The first and second electronic devices may be configured such that one or more particular user inputs are available for detection as the input from or for the first portable electronic device, but are not available for detection as input from or for the second electronic device. For example a tablet computer may be laid over a tabletop display device. Inputs made to the tabletop display device (without any first portable device being proximally positioned with respect to the tabletop display device) may be made using a peripheral device such as a mouse or trackball, but the tabletop display itself may not be touch sensitive. A user may be able to tap the touch-sensitive screen of a tablet computer (a first portable electronic device) laid in an overlying proximal position over the tabletop display device, and perform touch inputs which are taken as input to the tabletop display device.

The determined relative position of the first portable electronic device with respect to the second electronic device may be detected by using one or more touch-sensitive elements of the second electronic device. Thus if a smartphone (as a first device) is laid over a tablet computer (as a second device), a touch sensitive display of the tablet computer may be able to determine that the smartphone has been laid over part of its display, and also determine which part of its display is now covered by the smartphone.

The determined relative position of the first portable electronic device with respect to the second electronic device may be detected by a near-field communication (NFC) signal exchange between the first and second electronic devices. For example, a second device may comprise an NFC reader and a first portable device may comprise an NFC transmitter. When the first device is positioned in a position overlying the location of the NFC reader of the second device, then the two devices may communicate, such that images displayed on the second device may be displayed on the display of the first device and inputs made to the first device may be considered as inputs for the second device.

The display of the first portable electronic device may have a smaller area than the display of the second electronic device. For example, the first portable device may be a smartphone and the second device may be a tablet computer. As another example, the first portable device may be a tablet computer and the second device may be a tabletop device.

The apparatus may be configured to consider input from or for the first portable electronic device as input for the second electronic device by communicating the input for the first portable electronic device to the second electronic device using one or more of: near field communication (NFC); Bluetooth; Bluetooth low energy (BTLE, BLE); a wireless local area network (WLAN); an infra-red connection, an internet connection; a wired connection; or a combination of one or more of the same. Similarly the apparatus may be configured to consider output from or for the second electronic device as output from the first portable electronic device by communicating the output for the second electronic device to the first portable electronic device using one or more of: near field communication (NFC); Bluetooth; Bluetooth low energy (BTLE, BLE); a wireless local area network (WLAN); an infra-red connection, an internet connection; a wired connection; or a combination of one or more of the same.

The input from or for the first portable electronic device may correspond to one or more of: a single touch user input; a multi-touch user input; a single point contact touch user input; a multi-point contact touch user input; a swipe user input; a pinch user input; a static hover user input; a moving hover user input; a pressure-dependent user input; a deformation user input; a peripheral device user input; and an audio user input.

The first portable electronic device may be a display, a mobile telephone, a smartphone, a personal digital assistant, an electronic magnifying device, a graphics tablet, or a tablet computer. The second electronic device may be a portable electronic device, a display, a tablet computer, a graphics tablet, a tabletop display, a non-portable electronic device, a desktop computer, or a laptop computer. The apparatus may be the first portable electronic device, the second electronic device, a server, or a module for one or more of the same.

According to a further aspect, there is provided a system comprising a first portable electronic device, and a second electronic device, the system configured to, when the determined relative position of a first portable electronic device with respect to a second electronic device is within a predetermined overlying proximity position in which at least a portion of the first portable electronic device overlies the second electronic device, consider at least one of input from or for the first portable electronic device as input for the second electronic device and output from or for the second electronic device as output from the first portable electronic device.

According to a further aspect, there is provided a computer program comprising computer program code, the computer program code being configured to perform at least the following: when the determined relative position of a first portable electronic device with respect to a second electronic device is within a predetermined overlying proximity position in which at least a portion of the first portable electronic device overlies the second electronic device, consider at least one of input from or for the first portable electronic device as input for the second electronic device and output from or for the second electronic device as output from the first portable electronic device.

A computer program may be stored on a storage media (e.g. on a CD, a DVD, a memory stick or other non-transitory medium). A computer program may be configured to run on a device or apparatus as an application. An application may be run by a device or apparatus via an operating system. A computer program may form part of a computer program product.

According to a further aspect, there is provided a method, the method comprising considering, when the determined relative position of a first portable electronic device with respect to a second electronic device is within a predetermined overlying proximity position in which at least a portion of the first portable electronic device overlies the second electronic device, at least one of input from or for the first portable electronic device as input for the second electronic device and output from or for the second electronic device as output from the first portable electronic device.

According to a further aspect there is provided an apparatus comprising means for considering, when the determined relative position of a first portable electronic device with respect to a second electronic device is within a predetermined overlying proximity position in which at least a portion of the first portable electronic device overlies the second electronic device, at least one of input from or for the first portable electronic device as input for the second electronic device and output from or for the second electronic device as output from the first portable electronic device.

The present disclosure includes one or more corresponding aspects, embodiments or features in isolation or in various combinations whether or not specifically stated (including claimed) in that combination or in isolation. Corresponding means and corresponding function units (e.g. an input considerer, an output considerer, an input signaller, a display/output signaller, and a relative position determiner) for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates an example apparatus comprising a number of electronic components, including memory and a processor according to an embodiment disclosed herein;

FIG. 2 illustrates an example apparatus comprising a number of electronic components, including memory, a processor and a communication unit according to another embodiment disclosed herein;

FIG. 3 illustrates an example apparatus comprising a number of electronic components, including memory, a processor and a communication unit according to another embodiment disclosed herein;

FIGS. 4a-4b illustrate an example apparatus in communication with a remote server/cloud according to another embodiment disclosed herein;

FIGS. 5a-5d illustrate an example of a first portable electronic device positioned in a predetermined overlying proximal position with respect to a second device according to embodiments disclosed herein;

FIGS. 6a-6d illustrate output from the second device being considered as output from the first device according to embodiments disclosed herein;

FIG. 7 illustrates a smartphone positioned in a predetermined overlying proximal position with respect to a laptop computer according to embodiments disclosed herein;

FIG. 8 illustrates a tablet computer positioned in a predetermined overlying proximal position with respect to a tabletop display device according to embodiments disclosed herein;

FIG. 9 illustrates a flowchart according to an example method of the present disclosure; and

FIG. 10 illustrates schematically a computer readable medium providing a program.

### DESCRIPTION OF EXAMPLE ASPECTS/EMBODIMENTS

Different electronic devices provide different ways by which an input may be made, and by which output is provided. Certain electronic devices allow input to be made, for example, by clicking a pointer or touching a touch-sensitive screen. Output may be provided from an electronic device, for example, via a high resolution display screen.

Not all devices are capable of accepting input by all means. That is, not all devices comprise all possible input sensors. For example, a device such as a mobile telephone may have hover sensing capabilities, but a tablet computer may not have. If a user owns both devices, it may be beneficial for him to be able to use the mobile phone's hover sensitive display as an input device to provide input to the tablet computer. As another example, the user may find a particular user gesture input to be intuitive and useful, but this gesture may be recognised only by the smartphone and not by the tablet computer (for example, a gesture may be detected by, for example, a hover sensitive screen, accelerometer, magnetometer or gyroscope, which is present in the smartphone but not in the tablet computer). It may be beneficial for the user to be able to use the gesture inputs with the tablet computer as well as the smartphone even if the tablet computer is not configured to recognise the gestures as input to the tablet computer directly.

It may also be beneficial for the user to be able to use the mobile phone's hover sensitive display to display images which are related to images displayed on the tablet computer so that he can see on the mobile telephone where to make an input to the tablet computer. For example, if the user wishes to select an icon on the tablet computer by using the mobile telephone to make the input, it may be useful for the user if a representation of the icon is displayed on the mobile telephone screen for the user to interact with.

Examples disclosed herein may provide advantages and may overcome one or more of the abovementioned problems. A user is able to place a first portable device within a predetermined overlying proximity position of a second electronic device. When the relative position of the first device is determined to be within the predetermined overlying proximity position, an apparatus is configured to consider at least one of input from or for the first portable electronic device as input for the second electronic device and output from or for the second electronic device as output from the first portable electronic device.

As an example, a user is able to place a first portable smartphone with hover sensing capability on top of the display, in the predetermined overlying proximity position, of a second tablet computing device which does not have hover sensing capabilities. The smartphone device, in effect, lends its hover sensing capabilities to the tablet computing device, so that information on the tablet computing device's display can be manipulated by hover sensing methods through using the hover sensitive input display of the smartphone device. An image displayed on the tablet computing device may be displayed on the display of the smartphone, for example so that the user can see what information/graphical user interface element(s) he is interacting with on the tablet computing device. In a similar manner, other sensor functionalities may be lent by the smartphone device to the tablet computing device, such as, for example, a user being able to perform input user gestures which are not recognized by the tablet computer via the smartphone which does recognize the gesture (an example may be a pinch-and-grab selection/movement gesture recognized by the smartphone and not by the tablet computing device).

The above example may be implemented in one way as follows. The two devices exchange information about their relative positions. The tablet computing device sends a copy of the information that appears on its display to the smartphone device (it may be considered that output from the second electronic device is transmitted so it can be provided as output from the first portable electronic device). The smartphone device determines which segment/portion of the tablet computing device's display content should be shown on the display of the smartphone. One method for the devices to determine their relative positions is that the touch display of the tablet computing device can determine where on its display the smartphone device is placed. The smartphone device relays the hover sensing information that it detects to the tablet computing device (it maybe considered that input for the first portable electronic device being transmitted so it can be provided as input from the second electronic device). The information exchange may occur via close-proximity radio, for example.

Other examples depicted in the figures have been provided with reference numerals that correspond to similar features of earlier described examples. For example, feature number 100 can also correspond to numbers 200, 300 etc. These numbered features may appear in the figures but may not have been directly referred to within the description of these particular examples. These have still been provided in the figures to aid understanding of the further examples, particularly in relation to the features of similar earlier described examples.

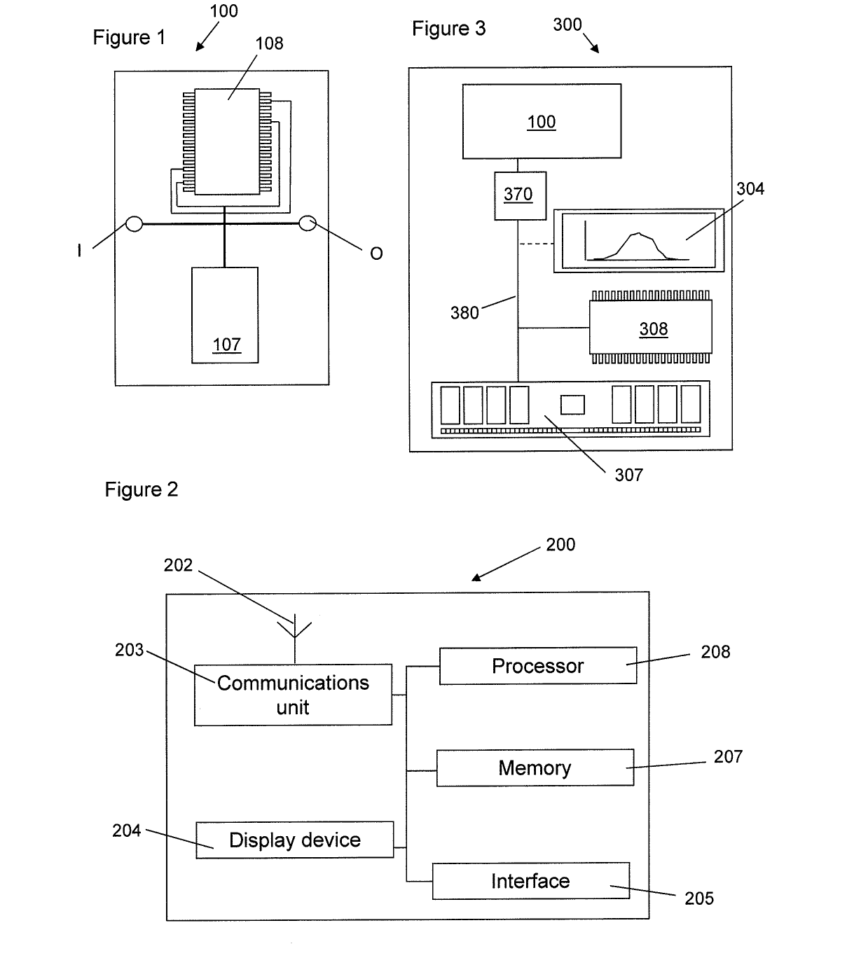

FIG. 1 shows an apparatus 100 comprising memory 107, a processor 108, input I and output O. In this embodiment only one processor and one memory are shown but it will be appreciated that other embodiments may utilise more than one processor and/or more than one memory (e.g. same or different processor/memory types).

In this embodiment the apparatus 100 is an Application Specific Integrated Circuit (ASIC) for a portable electronic device with a touch sensitive display. In other embodiments the apparatus 100 can be a module for such a device, or may be the device itself, wherein the processor 108 is a general purpose CPU of the device and the memory 107 is general purpose memory comprised by the device.

The input I allows for receipt of signalling to the apparatus 100 from further components, such as components of a portable electronic device (like a touch-sensitive display) or the like. The output O allows for onward provision of signalling from within the apparatus 100 to further components such as a display screen. In this embodiment the input I and output O are part of a connection bus that allows for connection of the apparatus 100 to further components.

The processor 108 is a general purpose processor dedicated to executing/processing information received via the input I in accordance with instructions stored in the form of computer program code on the memory 107. The output signalling generated by such operations from the processor 108 is provided onwards to further components via the output O.

The memory 107 (not necessarily a single memory unit) is a computer readable medium (solid state memory in this example, but may be other types of memory such as a hard drive, ROM, RAM, Flash or the like) that stores computer program code. This computer program code stores instructions that are executable by the processor 108, when the program code is run on the processor 108. The internal connections between the memory 107 and the processor 108 can be understood to, in one or more example embodiments, provide an active coupling between the processor 108 and the memory 107 to allow the processor 108 to access the computer program code stored on the memory 107.

In this example the input I, output O, processor 108 and memory 107 are all electrically connected to one another internally to allow for electrical communication between the respective components I, O, 107, 108. In this example the components are all located proximate to one another so as to be formed together as an ASIC, in other words, so as to be integrated together as a single chip/circuit that can be installed into an electronic device. In other examples one or more or all of the components may be located separately from one another.

FIG. 2 depicts an apparatus 200 of a further example embodiment, such as a mobile phone. In other example embodiments, the apparatus 200 may comprise a module for a mobile phone (or PDA or audio/video player), and may just comprise a suitably configured memory 207 and processor 208. The apparatus in certain embodiments could be a portable electronic device, a laptop computer, a mobile phone, a Smartphone, a tablet computer, a personal digital assistant, a server, a non-portable electronic device, a desktop computer, a monitor, or a module/circuitry for one or more of the same

The example embodiment of FIG. 2, in this case, comprises a display device 204 such as, for example, a Liquid Crystal Display (LCD), e-Ink or touch-screen user interface. The apparatus 200 of FIG. 2 is configured such that it may receive, include, and/or otherwise access data. For example, this example embodiment 200 comprises a communications unit 203, such as a receiver, transmitter, and/or transceiver, in communication with an antenna 202 for connecting to a wireless network and/or a port (not shown) for accepting a physical connection to a network, such that data may be received via one or more types of networks. This example embodiment comprises a memory 207 that stores data, possibly after being received via antenna 202 or port or after being generated at the user interface 205. The processor 208 may receive data from the user interface 205, from the memory 207, or from the communication unit 203. It will be appreciated that, in certain example embodiments, the display device 204 may incorporate the user interface 205. Regardless of the origin of the data, these data may be outputted to a user of apparatus 200 via the display device 204, and/or any other output devices provided with apparatus. The processor 208 may also store the data for later use in the memory 207. The memory 207 may store computer program code and/or applications which may be used to instruct/enable the processor 208 to perform functions (e.g. read, write, delete, edit or process data).

FIG. 3 depicts a further example embodiment of an electronic device 300, such as a tablet personal computer, a portable electronic device, a portable telecommunications device, a server or a module for such a device, the device comprising the apparatus 100 of FIG. 1. The apparatus 100 can be provided as a module for device 300, or even as a processor/memory for the device 300 or a processor/memory for a module for such a device 300. The device 300 comprises a processor 308 and a storage medium 307, which are connected (e.g. electrically and/or wirelessly) by a data bus 380. This data bus 380 can provide an active coupling between the processor 308 and the storage medium 307 to allow the processor 308 to access the computer program code. It will be appreciated that the components (e.g. memory, processor) of the device/apparatus may be linked via cloud computing architecture. For example, a storage device may be a remote server accessed via the Internet by the processor 308.

The apparatus 100 in FIG. 3 is connected (e.g. electrically and/or wirelessly) to an input/output interface 370 that receives the output from the apparatus 100 and transmits this to the device 300 via data bus 380. Interface 370 can be connected via the data bus 380 to a display 304 (touch-sensitive or otherwise) that provides information from the apparatus 100 to a user. Display 304 can be part of the device 300 or can be separate. The device 300 also comprises a processor 308 configured for general control of the apparatus 100 as well as the device 300 by providing signalling to, and receiving signalling from, other device components to manage their operation.

The storage medium 307 is configured to store computer code configured to perform, control or enable the operation of the apparatus 100. The storage medium 307 may be configured to store settings for the other device components. The processor 308 may access the storage medium 307 to retrieve the component settings in order to manage the operation of the other device components. The storage medium 307 may be a temporary storage medium such as a volatile random access memory. The storage medium 307 may also be a permanent storage medium such as a hard disk drive, a flash memory, a remote server (such as cloud storage) or a non-volatile random access memory. The storage medium 307 could be composed of different combinations of the same or different memory types.

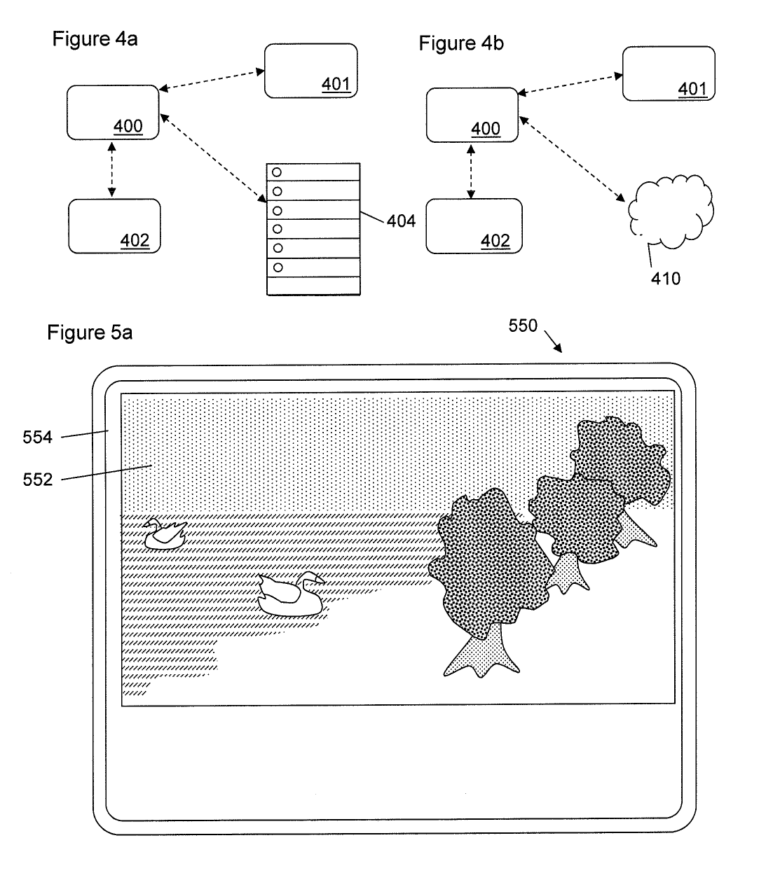

FIG. 4a shows an example of an apparatus 400 in communication with a remote server 404, a first portable electronic device 401 and a second electronic device 402. The remote server 404 is an example of a remote computing element, with which the apparatus may be in wired or wireless communication (e.g. via the internet, Bluetooth, a USB connection, or any other suitable connection as known to one skilled in the art). FIG. 4b shows an example of an apparatus in communication with a “cloud” 410 for cloud computing, a first portable electronic device 401 and a second electronic device 402. The remote “cloud” 410 is an example of a remote computing element which the apparatus 400 may be in communication with via the Internet, or a system of remote computers configured for cloud computing.

Of course, in FIGS. 4a and 4b, the apparatus 400 may form part of the first portable electronic device 401 or the second electronic apparatus 402, or they may each be separate as shown in the figures. Communication between the apparatus 400, the remote computing element 404, 410, and the first and second electronic devices 401, 402 may be via a communications unit 250, for example.

It may be that the input from or for the first portable electronic device 401 is considered at the remote computing element 404, 410 and then used as input for the second electronic device 402. It may be that the output from or for the second electronic device 401 is considered at the remote computing element 404, 410 and then passed as output from the first portable electronic device 402. The apparatus 400 may actually form part of the remote sever 404 or remote cloud 410. In such examples, conversion of the detected input to be used by the second electronic device 402, and/or conversion of the output from the second electronic device for display at the first portable electronic device may be conducted by the server/cloud or in conjunction with use of the server/cloud.

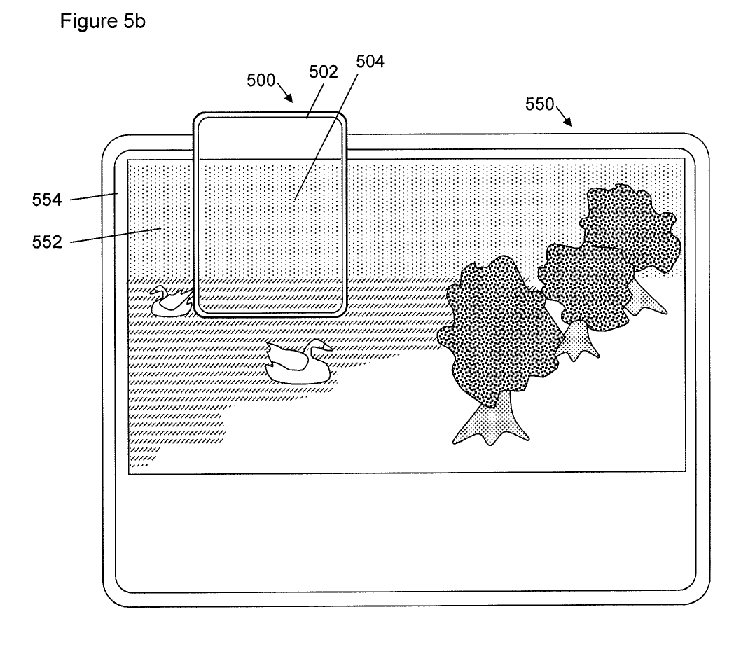

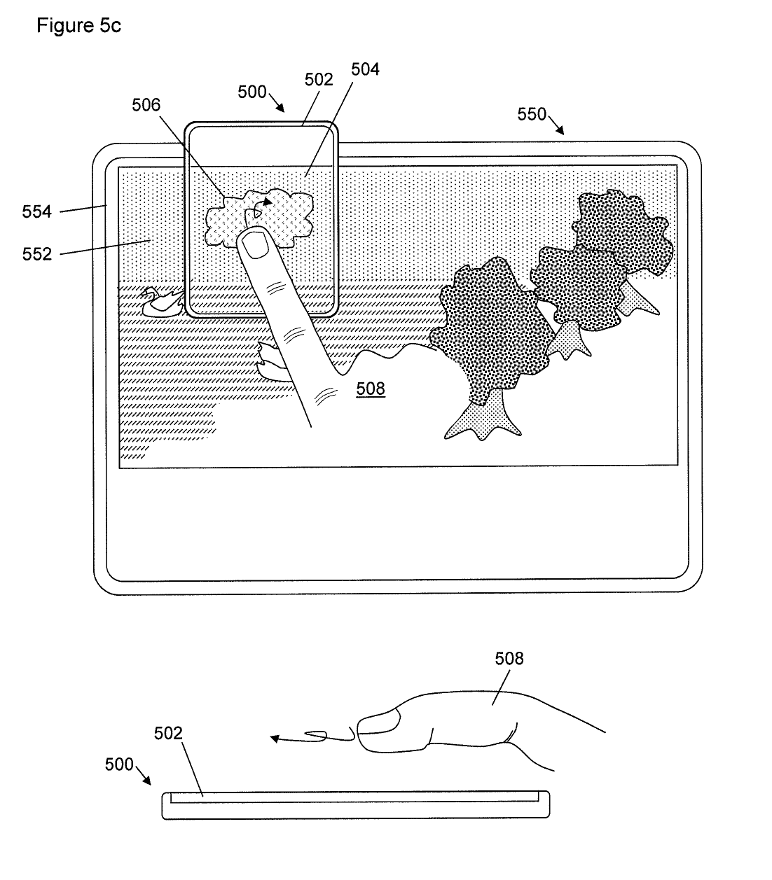

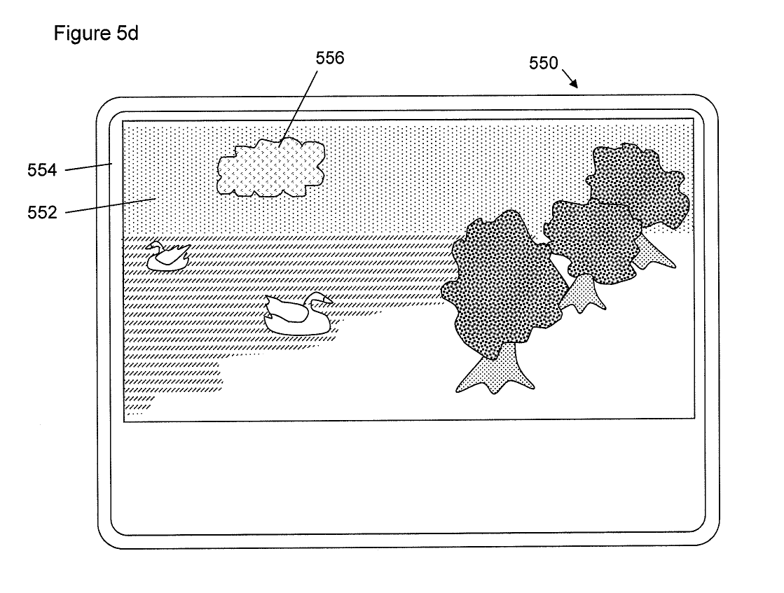

FIGS. 5a-5d illustrate an example of a first portable electronic device/apparatus 500 and a second electronic device 550. The apparatus may be as shown in FIGS. 1-4, and configured to perform functions as disclosed herein, may be the first portable electronic device/apparatus 500 or the second electronic device 550, or a module for one or the other. The apparatus may alternatively be a different apparatus to the first and second apparatus 500, 550, or module for a different apparatus such as a server. In this example the first portable electronic device 500 is a smartphone, and the second electronic device 550 is a tablet computer. Overall, FIGS. 5a-5d illustrate that when the determined relative position of the first portable electronic device 500 with respect to the second electronic device 550 is within a predetermined overlying proximity position, in which at least a portion of the first portable electronic device 500 overlies the second electronic device 550, the apparatus is configured to consider input from or for the first portable electronic device 500 as input for the second electronic device 550, and consider output from or for the second electronic device 550 as output from the first portable electronic device 500.

FIG. 5a shows a tablet computer 550 displaying an image 552 on the touch sensitive display 554 of the tablet computer 550 in a photograph/image manipulation application. The user wants to add an artistic effect to the image 552. Although they want to apply the artistic effect using hover gestures, the user is not able to because the touch sensitive display 554 of the tablet computer 550 is not hover sensitive.

FIG. 5b shows that the user has placed a smartphone 500 partially over the display screen 554 of the tablet computer 550. The relative position of the smartphone 500 with respect to the tablet computer 550 is determined to be within a predetermined overlying proximity position with respect to the tablet computer 550. The position of the smartphone 500 over the display of the tablet computer 550 in this example is determined by the touch sensitive display 554 of the tablet computer detecting where the smartphone 500 is making contact with the display 554.

In this example, if any portion of the smartphone 500 is determined to overlay any portion of the touch-sensitive display 554 of the tablet computer 550 then this is considered to fulfil the criterion of the smartphone 500 being positioned in a predetermined overlying proximity position. The predetermined overlying proximity position in this example is configured such that both a display 502 of the smartphone 500 and a display 554 of the tablet computer 550 are facing substantially the same direction.

Due to the determined relative positioning of the two devices, the apparatus is configured to consider output from tablet computer 550 as output from the smartphone 500. This is done in this example by the apparatus taking output signalling from the tablet computer 550 and providing it as input for the smartphone 500. The signalling may be via Bluetooth, for example. Thus the portion 504 of the image 552 (as display output) which is obscured by the smartphone 500 being positioned over the display 554 of the tablet computer 550 is provided as display output from the smartphone 500 itself. The image displayed on the tablet computer display 554 which is directly underneath the smartphone 500 is displayed as output 504 from the display of the smartphone 500. Therefore the user is able to see the image which is displayed underneath the smartphone 500. It may be considered that the two displays 502, 554 of the smartphone 500 and the tablet computer 550 are working together in concert to display the image over the two displays 502, 554.

FIG. 5c shows that the user is including a cloud 506 in the image 504 by making hover gesture inputs 508 over the hover sensitive display 502 of the smartphone 500. The hover sensitive display 502 is a user interface of the smartphone 500. The effect of the hover gestures 508 in this example is to apply artistic swirling paintbrush-like strokes which are displayed on the portion of the image 504 displayed as output on the display 502 of the smartphone 500. Although it cannot be seen due to the positioning of the smartphone 500 over the display 554 of the tablet computer 550, the hover gesture inputs 508 for the smartphone 500 are considered as input for the tablet computer 550.

FIG. 5d shows that the user has removed the smartphone 500 from the display of the tablet computer 550. The hover gesture inputs 508 made to the hover-sensitive display 502 of the smartphone 500 have been used as input for the tablet computer 550 to add the artistic effect 556 to the image 552 displayed on the tablet computer 500. Without the ability to make the hover input gestures 508 via the smartphone 500, the user would not be able to apply the artistic effect 556 in this way to the image 552 displayed on the tablet computer 550, because the tablet computer 550 is not configured to accept hover inputs 508. The smartphone 500 is determined to no longer be in a proximal overlying position with respect to the tablet computer 550, and thus the smartphone display 502 no longer displays an image corresponding to an image displayed on the table computer display 554.

Prior to removing the smartphone 500 from the display 554 of the tablet computer 550, the user in this example is able to move the position of the smartphone 500 over the display of the tablet computer 550. Provided that the smartphone 550 is determined to be with a predetermined overlying proximity position with respect to the display 554 of the tablet computer 550, as detected by the touch sensitive display 554, then the input and output communication between the two devices may continue (for example, movement of the cloud as the smartphone 500 is moved relative to the tablet computer 550). Once moved to a different proximal overlying different location on the display 544 the output provided to the smartphone 500 may be updated so that the display of the moved smartphone 500 displays the current image located underneath on the display 554 of the tablet computer 550. The new position of the smartphone 550 on the display 554 may be determined by the touch sensitive display 554 regularly detecting the position of the smartphone 550 on the display 554.

Similarly, while the smartphone 500 remains in one proximal overlying position on the display 554 of the tablet computer 550, as for example shown in FIGS. 5b and 5c, the user is able to move the image 552 displayed on the tablet computer display 554 by, for example, making a touch-and-drag user input to the display 554 of the tablet computer 550. The image displayed on the touch sensitive display 554 will change once the user has dragged the image to a new location. The new image portion located under the position of the smartphone 500 on the display 554 is updated so that the two devices always appear to be showing a single continuous image over their two displays 502, 554 working in concert. After the touch-and-drag input, the apparatus is configured to update the output provided to the smartphone 500 based on the new image displayed on the tablet computer display 554. A similar effect is obtained if a new image is loaded on the tablet computer such as a new photograph being displayed, and the image displayed on the display 502 of the smartphone 500 is updated as the image on the display 554 of the tablet computer 550 is updated.

In certain examples, the smartphone may be configured to act as a magnifying device to show a magnified view of the image 504 displayed corresponding to the portion of the image 552 located under the smartphone 500 on the display 554. Thus the smartphone 500 in this example is able to act both as a hover sensitive input device and as an electronic magnifying glass, allowing the user to make precise artistic gestures to modify the image 552, for example.

The first portable electronic device may have a smaller display than the display of the second electronic device. The first device may be a display, a mobile telephone, a smartphone, a personal digital assistant, an electronic magnifying device, a graphics tablet or a tablet computer. The second device may be a portable electronic device, a display, a tablet computer, a graphics tablet, a tabletop display, a non-portable electronic device, a desktop computer, or a laptop computer.

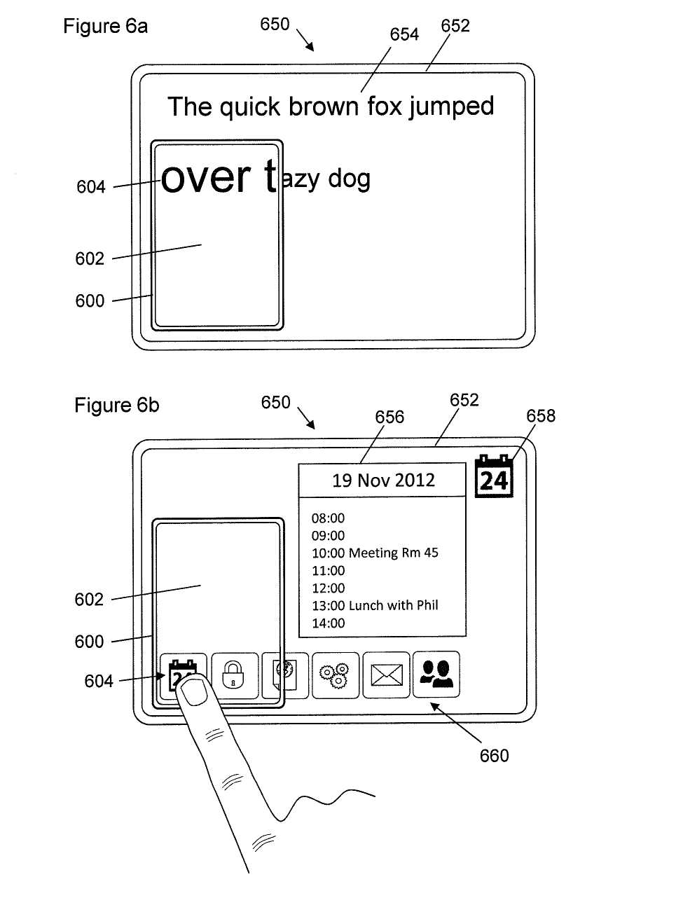

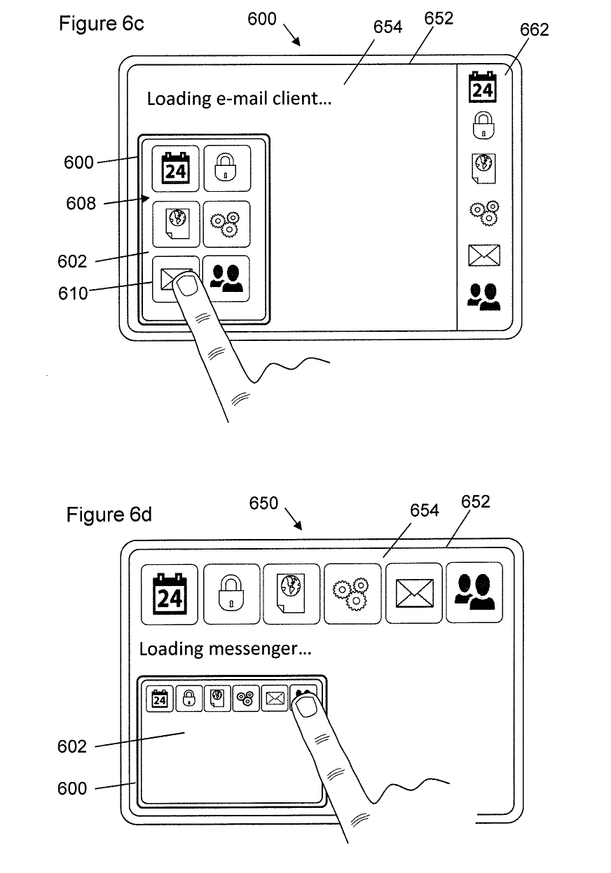

FIGS. 6a-6d illustrate different ways in which the output from or for the second electronic device may be provided as output from the first portable electronic device when the determined relative position of the first portable electronic device 500 with respect to the second electronic device 550 is within a predetermined overlying proximity position (in this example, the entire first device is overlying and within the borders of the display of the second device). In these examples the input from or for the first portable electronic device need not be considered as input for the second electronic device (although in other examples it may be).

In FIG. 6a, the display 602 of the first device 600 provides a magnification 604 of a portion of an image 654 represented on the display 652 of the second device 650. The portion of the image 654 in this example is partially obscured by the overlying first device 600. In other examples the first device 600 may act as a magnifier without obscuring the image displayed on the display 652 of the second device 650.

In FIG. 6b, the second device 650 is displaying a row of application icons 660 across the bottom of the display 652. The display 602 of the first device 600 provides a portion of the image 606 of the row of icons 660 which are represented on the display 652 of the second device 650. In this example the images displayed on the two display screens 602, 652 are directly overlapping as if to provide a single continuous image over the two displays 602, 652. The user may be able to make touch user inputs to the display 602 of the first device 600 which cannot be made to the display 652 of the second device 650. Thus the user is able to interact with the icons 606 displayed on the display 602 of the first device 600 and cause the associated application to load on the second device, for example. In this example the user has actuated a calendar application icon to open a calendar application 658 on the second device 650. Once the calendar icon is actuated, the open calendar application 656 is displayed on the display 652.

In FIG. 6c, the second device 650 is displaying a menu bar 662 of application icons along the right side of the display 652. The display 602 of the first device 600 provides a menu 608 associated with the menu bar content 662 provided on the display 652 of the second device 650. The user is able to interact with the icons in the menu 608 displayed on the display 602 of the first device 600 and cause the associated application to load on the second device. In this example the user is loading an email client 664 by interacting with an e-mail application icon 610 displayed on the display 602 of the first device 600. This may be advantageous if the menu bar displayed on the second display 652 can display a maximum of icons (for example, five icons maximum) and the display 602 of the second device 600 can be used to display a greater number of icons (for example, up to 18 icons), to minimise any scrolling the user would have to make in relation to the menu bar 662 to display different application icons. In other examples, the display of a menu on the display 602 of the second device 600 may be advantageous if displaying an associated menu on the first device would be troublesome for the user. For example if the user would be required to perform several user inputs (such as “unhide menu” and/or “scroll through menu”) to show a menu of the second device 550, but the menu is readily available on the first device 500, this may provide for easier use. Scrolling of the menu displayed on the first device 600 may also scroll the menu displayed on the second device 650.

In FIG. 6d, the second device 650 is displaying a copy of the entire image displayed on the display 652 of the second device 650. The user is able to interact with the icons in the menu 608 displayed on the display 602 of the first device 600 and cause the associated application to load on the second device. This may be advantageous if the user can perform user inputs using the user interface of the first device 600 which are not possible using the user interface of the second device. For example if the second device is not touch sensitive and user inputs are made by controlling a pointer with a peripheral device, the user may find it advantageous to position his touch-sensitive portable device over a part of a display of the second device and then use touch inputs to for example, move and select icons.

Other example user inputs which may be made to and detected by the first device 500, 600 but not made to and detected by the second device 550, 650 include a single touch user input; a multi-touch user input; a single point contact touch user input (for example to a touch sensitive sensor or display); a multi-point contact touch user input; a swipe user input; a pinch user input; a static hover user input (for example to a hover sensitive sensor or display); a moving hover user input; a pressure-dependent user input (for example to a pressure sensor or pressure sensitive display); a deformation user input (for example to a deformable user input device); a peripheral device user input (for example using a keyboard or mouse); and an audio user input (for example using voice recognition to enter commands to a device via a microphone).

In the above examples, the display 602 of the first portable electronic device 600 may be considered to provide at least a portion of an image which was represented on the display 652 of the second electronic device 650 immediately prior to the first and second devices 600, 650 being in predetermined overlying proximity. For example, when the first device 600 is determined to be in the predetermined overlying proximity position, the display output from the second device 650 can be provided as display output from the first device 600. In other examples the display output from the second device 650 can be provided as display output from the first device 600 after a particular user input to link the two devices 600, 650 is made, or after user acceptance of a “proximal device detected” notification from the first or second device or the apparatus, for example. The display output need not necessarily be provided on the first device based only on the relative positions of the two devices 600, 650 being determined to be in overlying proximity.

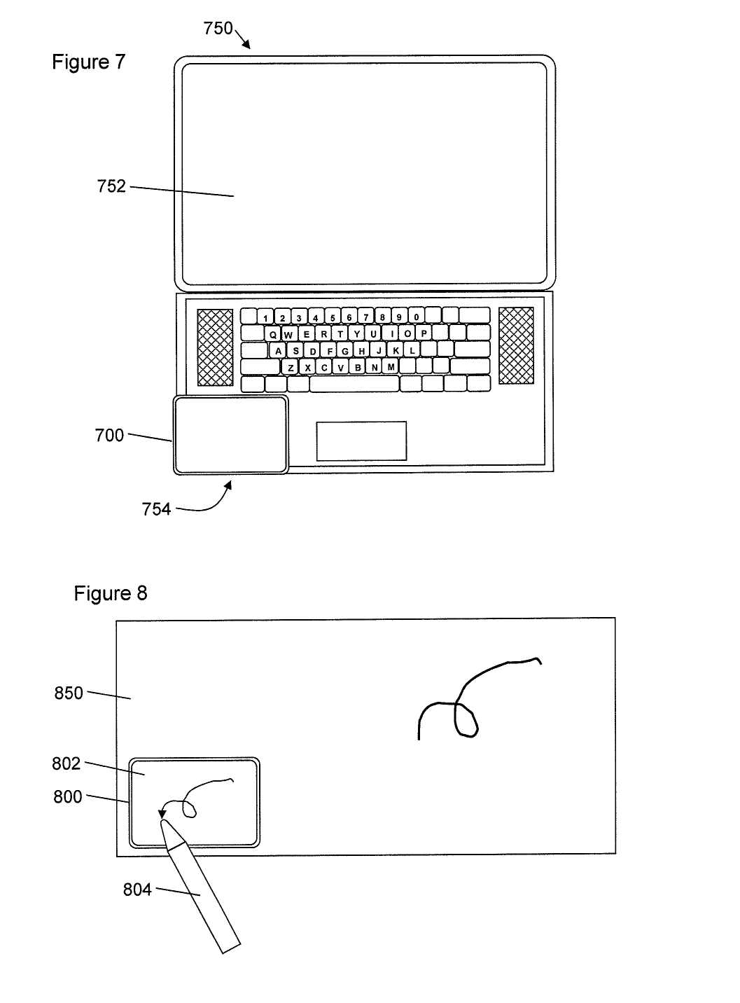

FIG. 7 illustrates a first portable electronic device 700 overlying a predetermined overlying proximity position of a second electronic device 750 wherein the predetermined overlying proximity position is not a position on the display 752 of the second device 750. In this example, the first device 700 is a mobile telephone and the second device 750 is a laptop computer 750 (but could in other examples be a desktop computer). The laptop computer 750 comprises an NFC reader 754 in the body of the computer. When the smartphone 700 is positioned proximal to and overlying the position of the NFC reader 754 (located in this example in the keyboard area), then a link is identified between the two devices 700, 750. Due to the link, the apparatus (which in this example is located in the laptop computer, but which in other examples may be in the mobile telephone or remote from the two) considers input for the mobile telephone 700 as input for the laptop computer 750, so that the user can interact with the mobile telephone display screen as a user interface for controlling the laptop computer. The mobile telephone may be considered to behave as a peripheral user input device. In addition (but not necessarily), an image displayed on the screen 752 of the laptop computer 750 may be displayed on the display of the mobile telephone 700, so for example the user can interact with displayed elements on the display of the mobile telephone 700 and the inputs are effected on the laptop computer 750 in relation to the corresponding displayed elements.

FIG. 8 illustrates a first portable electronic device 800 overlying a predetermined overlying proximity position of a second electronic device 850. In this example the second electronic device is a tabletop display screen which accepts input via a peripheral device such as a mouse or keyboard but which is not touch and/or hover sensitive. In this example, the first device 800 is a portable electronic device with a touch sensitive screen 802 such as a tablet or smartphone. The user is able to draw images using a stylus 804 (e.g., a pen or finger) on the display 802 of the portable electronic device 800 and this input is accepted as input for the second electronic device 850. Thus the apparatus may be configured to consider input only, as in this example the display of the first portable electronic device does not display any output corresponding to output from the second device 850. In other examples the display of the first portable electronic device 800 and the second electronic device 850 may display images corresponding to images displayed on the second electronic device 850.

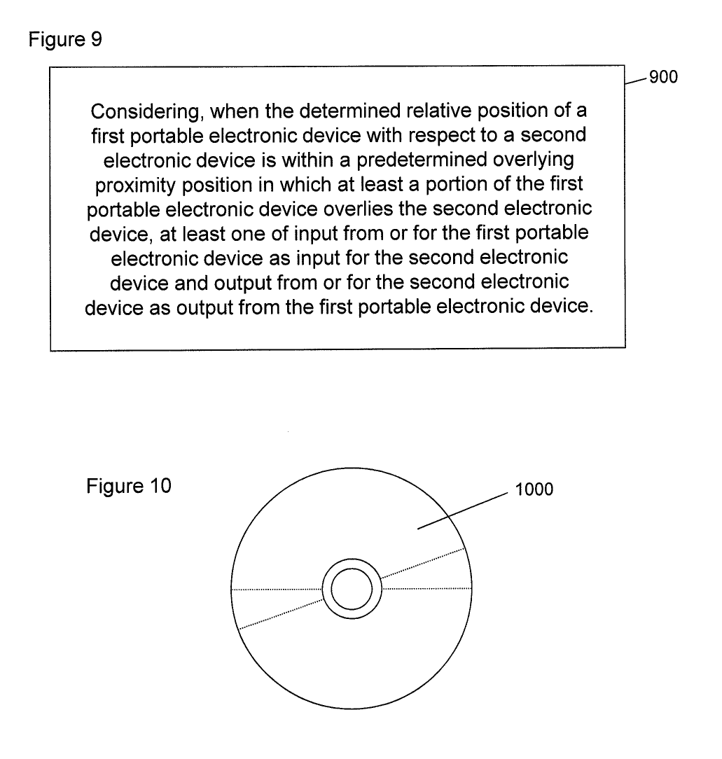

FIG. 9 illustrates a method according to an example embodiment of the present disclosure. The method comprises considering, when the determined relative position of a first portable electronic device with respect to a second electronic device is within a predetermined overlying proximity position in which at least a portion of the first portable electronic device overlies the second electronic device, at least one of input from or for the first portable electronic device as input for the second electronic device and output from or for the second electronic device as output from the first portable electronic device. 900.

FIG. 10 illustrates schematically a computer/processor readable medium 1000 providing a program according to an embodiment. In this example, the computer/processor readable medium is a disc such as a Digital Versatile Disc (DVD) or a compact disc (CD). In other embodiments, the computer readable medium may be any medium that has been programmed in such a way as to carry out the functionality herein described. The computer program code may be distributed between the multiple memories of the same type, or multiple memories of a different type, such as ROM, RAM, flash, hard disk, solid state, etc.

Any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

Any mentioned apparatus/elements/processor may have other functions in addition to the mentioned functions, and that these functions may be performed by the same apparatus/elements/processor. One or more disclosed aspects may encompass the electronic distribution of associated computer programs and computer programs (which may be source/transport encoded) recorded on an appropriate carrier (e.g. memory, signal).

Any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

The term “signalling” may refer to one or more signals transmitted as a series of transmitted and/or received electrical/optical signals. The series of signals may comprise one, two, three, four or even more individual signal components or distinct signals to make up said signalling. Some or all of these individual signals may be transmitted/received by wireless or wired communication simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features.

In view of the foregoing description it will be evident to a person skilled in the art that various modifications may be made within the scope of the disclosure.

While there have been shown and described and pointed out fundamental novel features as applied to example embodiments thereof, it will be understood that various omissions and substitutions and changes in the form and details of the devices and methods described may be made by those skilled in the art without departing from the scope of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising:
at least one processor; and
at least one memory including computer program code,
the at least one memory and the computer program code configured to, with the at least one processor, cause the apparatus to perform at least the following:
when the determined relative position of a first portable electronic device with respect to a second electronic device is within a predetermined overlying proximity position in which at least a portion of the first portable electronic device overlies the second electronic device, consider at least one of:
input from or for the first portable electronic device as input for the second electronic device; and
output from or for the second electronic device as output from the first portable electronic device.

2. The apparatus of claim 1, wherein the predetermined overlying proximity position is at least one of:
a position in which at least a portion of a display of the first portable device overlies a display of the second electronic device; and
a position in which an entire display of the first portable device overlies a larger display of the second electronic device.

3. The apparatus of claim 1, wherein the apparatus is configured to consider the input from or for the first portable electronic device as input for the second electronic device by taking input signalling from or for the first portable electronic device and providing it as input signalling for the second electronic device.

4. The apparatus of claim 1, wherein the apparatus is configured to consider the output from or for the second electronic device as output from the first portable electronic device by taking output signalling from or for the second electronic device and providing it as input for the first portable electronic device to allow for output by the first portable electronic device.

5. The apparatus of claim 1, wherein the apparatus is configured to consider the output from or for the second electronic device as output from the first portable electronic device by providing output display signalling to one or more of the devices such that displays of the respective devices work together in concert.

6. The apparatus of claim 5, wherein the displays of the respective devices work together in concert such that at least one of:
the display of the first portable electronic device provides a magnification of a portion of an image represented on the display of the second electronic device;
the display of the first portable electronic device provides a magnification of a portion of an image represented on the display of the second electronic device which is at least partially obscured by the overlying first portable electronic device;
the display of the first portable electronic device provides a portion of an image represented on the display of the second electronic device;
the display of the first portable electronic device provides a menu associated with content provided on the display of the second electronic device; and
the display of the first portable electronic device provides a portion of an image which was, immediately prior to the first and second devices being in the predetermined overlying proximity, represented on the display of the second electronic device

7. The apparatus of claim 1, wherein the apparatus is configured to determine whether the relative position of the first portable device with respect to the second portable device is within the predetermined overlying proximity position.

8. The apparatus of claim 1, wherein the predetermined overlying proximity position comprises the first portable electronic device proximally located over the second electronic device such that both a display of the first portable electronic device and a display of the second electronic device are facing substantially the same direction.

9. The apparatus of claim 1, wherein the input from or for the first portable electronic device is a user input made using a user interface of the first portable electronic device.

10. The apparatus of claim 1, wherein the first and second electronic devices are configured such that one or more particular user inputs are available for detection as the input from or for the first portable electronic device, but are not available for detection as input from or for the second electronic device.

11. The apparatus of claim 1, wherein the determined relative position of the first portable electronic device with respect to the second electronic device is detected by using one or more touch-sensitive elements of the second electronic device.

12. The apparatus of claim 1, wherein the determined relative position of the first portable electronic device with respect to the second electronic device is detected by a near-field communication signal exchange between the first and second electronic devices.

13. The apparatus of claim 3, wherein the apparatus is configured to consider input from or for the first portable electronic device as input for the second electronic device by communicating the input for the first portable electronic device to the second electronic device using one or more of:
near field communication; Bluetooth; Bluetooth low energy; a wireless local area network; an infra-red connection; an internet connection; a wired connection; or a combination of one or more of the same.

14. The apparatus of claim 1, wherein the input from or for the first portable electronic device corresponds to one or more of:
a single touch user input; a multi-touch user input; a single point contact touch user input; a multi-point contact touch user input; a swipe user input; a pinch user input; a static hover user input; a moving hover user input; a pressure-dependent user input; a deformation user input; a peripheral device user input; and an audio user input.

15. The apparatus of claim 1, wherein the first portable electronic device is a display, a mobile telephone, a smartphone, a personal digital assistant, an electronic magnifying device, a graphics tablet or a tablet computer.

16. The apparatus of claim 1, wherein the second electronic device is a portable electronic device, a display, a tablet computer, a graphics tablet, a tabletop display, a non-portable electronic device, a desktop computer, or a laptop computer.

17. The apparatus of claim 1, wherein the apparatus is the first portable electronic device,
the second electronic device, a server, or a module for one or more of the same.

18. A system comprising:
a first portable electronic device; and
a second electronic device;
the system configured to, when the determined relative position of a first portable electronic device with respect to a second electronic device is within a predetermined overlying proximity position in which at least a portion of the first portable electronic device overlies the second electronic device, consider at least one of:
input from or for the first portable electronic device as input for the second electronic device; and
output from or for the second electronic device as output from the first portable electronic device.

19. A computer readable medium comprising computer program code stored thereon, the computer readable medium and computer program code being configured to, when run on at least one processor, perform at least the following:
when the determined relative position of a first portable electronic device with respect to a second electronic device is within a predetermined overlying proximity position in which at least a portion of the first portable electronic device overlies the second electronic device, consider at least one of:
input from or for the first portable electronic device as input for the second electronic device; and
output from or for the second electronic device as output from the first portable electronic device.

20. A method comprising:
considering, when the determined relative position of a first portable electronic device with respect to a second electronic device is within a predetermined overlying proximity position in which at least a portion of the first portable electronic device overlies the second electronic device, at least one of:
input from or for the first portable electronic device as input for the second electronic device; and
output from or for the second electronic device as output from the first portable electronic device.
